(19) United States
(12) Patent Application Publication
(10) Pub. No.: US 2025/0327902 A1
(43) Pub. Date: Oct. 23, 2025

(54) LIDAR, DATA PROCESSING METHOD AND LIGHT DETECTION AND DATA ACQUISITION AND PROCESSING DEVICE

(71) Applicant: HESAI TECHNOLOGY CO., LTD., Shanghai (CN)

(72) Inventors: Jun TAO, Shanghai (CN); Shiwei ZHENG, Shanghai (CN); Shaoqing XIANG, Shanghai (CN)

(21) Appl. No.: 19/231,184

(22) Filed: Jun. 6, 2025

Related U.S. Application Data
(63) Continuation of application No. PCT/CN2023/115383, filed on Aug. 29, 2023.

(30) Foreign Application Priority Data
Dec. 7, 2022 (CN) 202211560601.9

(51) Int. Cl. G01S 7/481; G01S 17/08

(52) U.S. Cl. CPC G01S 7/4816; G01S 7/4815; G01S 17/08

(57) ABSTRACT

LiDAR, data processing method, and light detection and data acquisition and processing device are proved. In one aspect, a LiDAR includes: a transmitter device configured to transmit a detection light beam for detecting an object, a detector device comprising a plurality of detector units, a first detector unit of the plurality of the detector units comprising a first pixel array, the first pixel array comprising a first pixel configured to convert an echo into a first electrical signal, and a second pixel adjacent to the first pixel and configured to convert the echo into a second electrical signal, a data processor device coupled with the detector device and configured to reconstruct the first electrical signal and the second electrical signal to obtain a first reconstructed signal array comprising a first reconstructed electrical signal, and determine a point cloud based on the first reconstructed signal array.

### CROSS-REFERENCE TO RELATED APPLICATIONS

This application is a continuation application of PCT Application No. PCT/CN2023/115383, filed on Aug. 29, 2023, which claims priority to Chinese Patent Application No. 202211560601.9, filed on Dec. 7, 2022. This disclosures of the aforementioned applications are hereby incorporated by reference in their entireties.

### TECHNICAL FIELD

This disclosure relates to the field of LiDAR technology, in particular to a LiDAR, a data processing method for a LiDAR and an integrated light detection and data acquisition and processing device.

### BACKGROUND

LiDAR is a commonly used ranging sensor with advantages such as long detection distance, high resolution, strong resistance to active interference, small size, and light weight, etc. It is widely used in the fields of intelligent robots, unmanned aerial vehicles, and autonomous driving. Currently, the operating modes of LiDAR mainly include mechanical rotating type, rotating mirror-type, and galvanometer-type (such as micro-electro-mechanical system, MEMS). However, most of the LiDARs implement echo detection by using discrete detector units such as avalanche photodiode (APD) and silicon photomultiplier (SiPM). The detected electrical signals are converted by an analog-to-digital conversion chip, such as an analog-to-digital converter (ADC) or a time-to-digital converter (TDC), and then echo identification and time measurement are performed on the converted electric signal by a digital processing chip.

FIG. 1a illustrates a conventional LiDAR based on discrete photosensitive units in which multiple transmitter units and multiple detector units are included. The transmitter device TX includes N transmitter units (L1, L2, L3, . . . , LN exemplarily illustrated in FIG. 1a), and the detector device RX includes N detector units (D1, D2, D3, . . . , DN exemplarily illustrated in FIG. 1a). The detector units can be avalanche photodiode (APD), silicon photomultiplier (SiPM), etc. N transmitter units and N detector units form N detecting channels (i.e., N lines). Most conventional LiDARs use the way of point scanning to detect objects. That is, a transmitter unit transmits a detection light beam, the detection light beam is reflected from external objects and then the reflected light is detected by a corresponding detector unit. After subsequent processing by the circuit, a data point in a point cloud is generated. N transmitter units and N detector units are driven by a scanning device (such as a mechanical rotating type LiDAR), or the transmitted light beams from N transmitter units are deflected by a scanning device, thus covering a detection range with a certain vertical and horizontal field of view. However, it is very difficult to further increase the number of transmitter units and detector units in conventional LiDAR, and thus it is difficult to achieve a higher line number, such as 256 or more, and the resolution of the point cloud cannot be adjusted easily.

In addition, in order to achieve a higher line number and longer ranging distance, light spots on adjacent discrete detector units overlap each other. As shown in FIG. 1b, when the resolution of the point cloud is 0.05°×0.05°, for example, taking the vertical direction as an example, due to technical limitations, the divergence angle of the light spots usually cannot be made smaller, can be only 0.1° or even larger. This leads to the existence of overlapping regions between echo light spots on adjacent detector units (as shown in FIG. 1b, an overlap exists between the echo light spots on detector units D1 and D2). The overlapping region is repeatedly measured, resulting in low utilization rate in photon information. The dark grids represent transmitting/detector units in operation. The circle in solid line represents the current echo light spot on the detector unit. The detection light beam transmitted by the transmitter unit currently in operation is reflected and the current echo light spot is produced. The circle in dashed line represents the previous light spot on the detector unit. The detection light beam transmitted by the transmitter unit at the previous moment is reflected and the previous echo light spot was produced.

The content of the background section only represents the technology known to the discloser, which does not necessarily represent the existing technology in this field.

### SUMMARY

To address one or more of the problems in the prior art, this disclosure provides a LiDAR, which can generate a point cloud with a higher line number and flexibly adjustable angular resolution, and enhanced long-range detection capability.

The LiDAR includes:

a transmitter device configured to transmit a detection light beam for detecting an object,

a detector device including a plurality of detector units, each of the detector units including a pixel array, wherein each pixel responds to an echo of the detection light beam reflected from the object and converts the echo into an electrical signal, and a data processor device coupled with the detector device and configured to:

for at least one of the detector units, reconstruct based on electrical signals output by the pixel array of the detector unit to obtain a reconstructed signal array, and generate a point cloud of LiDAR based on the reconstructed signal array,

wherein each signal in the reconstructed signal array is obtained based on electrical signals output by a plurality of adjacent pixels.

In an aspect of the present disclosure, each pixel includes a plurality of single photon avalanche diodes, each of the single photon avalanche diodes is configured to be independently gated and addressed. The data processor device is configured to traverse, for at least one of the detector units, the electrical signals output by the pixel array of the detector unit, and reconstruct based on the electrical signals output by the pixel array of the detector unit to obtain the reconstructed signal array.

In an aspect of the present disclosure, the at least one of the detector units corresponds to a particular field of view of the LiDAR, in a field of view outside the particular field of view of the LiDAR, the data processor device is configured to generate a point cloud of LiDAR based on electrical signals output by the pixel array of one detector unit.

In an aspect of the present disclosure, the at least one of the detector units include a first detector unit and a second detector unit, wherein the first detector unit and the second detector unit are two detector units of a same configuration, wherein the data processor device is configured to:

reconstruct electrical signals output by the pixel array of the first detector unit to obtain a first reconstructed signal array, reconstruct based on electrical signals output by the pixel array of the second detector unit to obtain a second reconstructed signal array, and

generate m points in the point cloud of LiDAR based on the first reconstructed signal array, generate n points in the point cloud of LiDAR based on the second reconstructed signal array, wherein m is greater than n.

In an aspect of the present disclosure, the first detector unit corresponds to a central area of the field of view of the LiDAR, and the second detector unit corresponds to an area outside the central area of the field of view of the LiDAR.

In an aspect of the present disclosure, the data processor device is configured to: obtain a ROI around the LiDAR, and

set a detector unit corresponding to the ROI as the at least one of the detector units.

In an aspect of the present disclosure, the data processor device is configured to:

perform convolution on the electric signals output by the pixel array of the detector unit using a convolution kernel and a predetermined convolution stride, to obtain the reconstructed signal array.

In an aspect of the present disclosure, the convolution stride can be adjusted based on a field of view corresponding to the detector unit.

In an aspect of the present disclosure, the convolution stride of a central area of the field of view of the LiDAR is smaller than a convolution stride of a marginal area of the field of view of the LiDAR.

In an aspect of the present disclosure, the transmitter device includes a plurality of transmitter units, and a number of rows of the reconstructed signal array is greater than a number of the transmitter units.

In an aspect of the present disclosure, a dimension of the reconstructed signal array is less than a dimension of the pixel array.

The present disclosure also provides a data processing method for a LiDAR, wherein a detector device of the LiDAR includes a plurality of detector units, each of the detector units including a pixel array, wherein each pixel responds to an echo of the detection light beam reflected from an object and converts the echo into an electrical signal, the data processing method including:

S101: for at least one of the detector units, reconstruct electrical signals output by the pixel array of the detector unit to obtain a reconstructed signal array, and

S102, generating a point cloud of LiDAR based on the reconstructed signal array,

wherein each signal in the reconstructed signal array is obtained based on electrical signals output by a plurality of adjacent pixels.

In an aspect of the present disclosure, each pixel includes a plurality of single photon avalanche diodes arranged in a matrix, each single photon avalanche diode is configured to be independently gated and addressed. The step S101 includes: traversing, for at least one of the detector units, the electrical signals output by the pixel array of the detector unit, reconstructing the electrical signals output by the pixel array of the detector unit to obtain the reconstructed signal array.

In an aspect of the present disclosure, the at least one of the detector units correspond to a particular field of view of the LiDAR, the data processing method further includes:

in a field of view outside the particular field of view of the LiDAR, configuring the data processor device to generate a point in the point cloud of LiDAR based on electrical signals output by the pixel array of one detector unit.

In an aspect of the present disclosure, the at least one of the detector units includes a first detector unit and a second detector unit, wherein the first detector unit and the second detector unit are two detector units of a same configuration, and wherein,

the step S101 includes: reconstructing electrical signals output by the pixel array of the first detector unit to obtain a first reconstructed signal array, reconstructing electrical signals output by the pixel array of the second detector unit to obtain a second reconstructed signal array, and

the step S102 includes: generating m points in the point cloud of LiDAR based on the first reconstructed signal array, and generating n points in the point cloud of LiDAR based on the second reconstructed signal array, wherein m is greater than n.

In an aspect of the present disclosure, the first detector unit corresponds to a central area of the field of view of the LiDAR, and the second detector unit corresponds to an area outside the central area of the field of view of the LiDAR.

In an aspect of the present disclosure, the data processing method further includes:

obtaining a ROI around the LiDAR, and

setting a detector unit corresponding to the ROI as the at least one of the detector units.

In an aspect of the present disclosure, the step S101 includes:

performing convolution on the electric signals output by the pixel array of the detector unit using a convolution kernel and a predetermined convolution stride, to obtain the reconstructed signal array.

In an aspect of the present disclosure, the convolution stride can be adjusted based on a field of view corresponding to the detector unit.

In an aspect of the present disclosure, the convolution stride of a central area of the field of view of the LiDAR is smaller than a convolution of a marginal area of the field of view of the LiDAR.

In an aspect of the present disclosure, the LiDAR further includes a transmitter device, the transmitter device includes a plurality of transmitter units, and a number of rows of the reconstructed signal array is greater than a number of the transmitter units.

In an aspect of the present disclosure, a dimension of the reconstructed signal array is less than a dimension of the pixel array.

The present disclosure also provides an integrated light detection and data acquisition and processor device including:

a plurality of detector units, each of the detector units including a pixel array, wherein each pixel responds to an echo light signal and converts the echo light signal into an electrical signal, and

a data acquisition and processing device, coupled with the plurality of detector units and configured to:

with respect to at least one of the detector units, obtain electrical signals output by the pixel array of the detector unit, reconstruct the electrical signals output by the pixel array of the detector unit to obtain a reconstructed signal array, and generate a point cloud of LiDAR based on the reconstructed signal array,

wherein each signal in the reconstructed signal array is obtained based on electrical signals output by a plurality of adjacent pixels.

As compared to the prior art, the technical solution of this disclosure can obtain a reconstructed signal array in which the signal is stronger by reconstructing the electrical signals output by the pixel array of the detector unit. A point cloud of LiDAR with a higher line number can be generated based on the reconstructed signal array, improving long-range detection capability of the LiDAR, which is beneficial for obtaining more effective and reliable detection results. The angular resolution of the point cloud of LiDAR can be flexibly adjusted by adjusting the convolution stride, which can support various configurations including global densification of the point cloud and densification in partial regions of the point cloud. In addition, based on the technical solution of this disclosure, the overlap regions of light spots are small, which can improve the utilization rate of photons and reduce the power consumption of the LiDAR.

### BRIEF DESCRIPTION OF THE DRAWINGS

The drawings forming part of this disclosure are used to provide further understanding to this disclosure, and the exemplary embodiments of this disclosure and the description thereof are used to explain this disclosure, which do not form an improper limitation to this disclosure. In the drawings:

FIG. 1a schematically illustrates an existing LiDAR based on discrete photosensitive units in which multiple transmitter units and multiple detector units are included,

FIG. 1b schematically illustrates the overlapping region between echo light spots in existing detection based on discrete photosensitive units,

FIG. 2 schematically illustrates a LiDAR consistent with some embodiments of this disclosure,

FIGS. 3a and 3b schematically illustrate respectively transmitter devices consistent with some embodiments of this disclosure,

FIG. 4a and FIG. 4b schematically illustrate respectively a detector device consistent with some embodiments of this disclosure,

FIG. 5a and FIG. 5b schematically illustrate respectively a process of obtaining a reconstructed signal array by performing convolution on the electrical signals output by a pixel array of a detector unit consistent with some embodiments of this disclosure,

FIG. 6 schematically illustrates a reconstructed signal array obtained by performing reconstruction on arrays of pixels of a plurality of detector units for different fields of view consistent with some embodiments of this disclosure,

FIG. 7 schematically illustrates an operating mode of the detector unit consistent with some embodiments of this disclosure,

FIG. 8 schematically illustrates a detecting chip consistent with some embodiments of this disclosure,

FIG. 9 schematically illustrates a structure of a LiDAR consistent with some embodiments of this disclosure,

FIG. 10 schematically illustrates an integrated light detection and data acquisition and processor device consistent with some embodiments of this disclosure,

FIG. 11 schematically illustrates an integrated light detection and data acquisition and processor device consistent with some embodiments of this disclosure, and

FIG. 12 schematically illustrates a flow diagram of a data processing method for a LiDAR consistent with some embodiments of this disclosure.

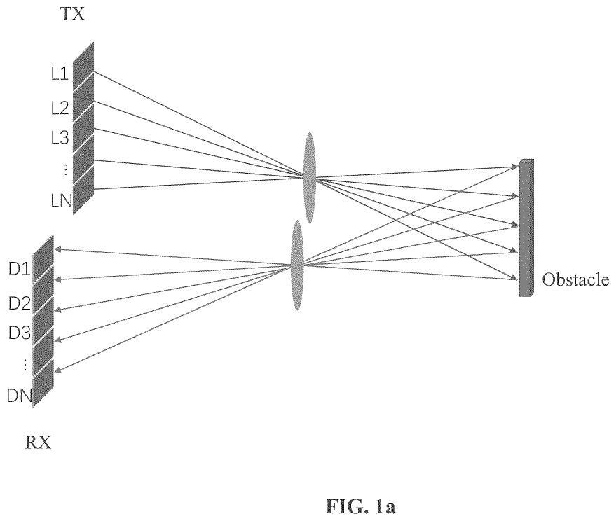

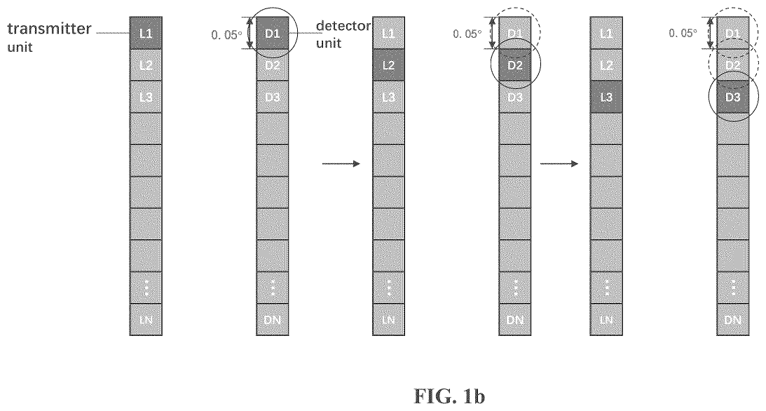

### DETAILED DESCRIPTION

In the following, only some exemplary embodiments are briefly described. The described embodiments can be modified in various different ways without departing from the spirit or scope of the present disclosure, as would be apparent to those skilled in the art. Accordingly, the drawings and descriptions are to be regarded as illustrative and not restrictive in nature.

In the description of the present disclosure, it needs to be understood that the orientation or position relations denoted by such terms as “central” “longitudinal” “latitudinal” “length” “width” “thickness” “above” “below” “front” “rear” “left” “right” “vertical” “horizontal” “top” “bottom” “inside” “outside” “clockwise” “counterclockwise” and the like are based on the orientation or position relations as shown in the accompanying drawings, and are used only for the purpose of facilitating description of the present disclosure and simplification of the description, instead of indicating or suggesting that the denoted devices or elements must be oriented specifically, or configured or operated in a specific orientation. Thus, such terms should not be construed to limit the present disclosure. In addition, such terms as “first” and “second” are only used for the purpose of description, rather than indicating or suggesting relative importance or implicitly indicating the number of the denoted technical features. Accordingly, features defined with “first” and “second” can, expressly or implicitly, include one or more of the features. In the description of the present disclosure, “plurality” means two or more, unless otherwise defined explicitly and specifically.

In the description of the present disclosure, it needs to be noted that, unless otherwise specified and defined explicitly, such terms as “installation” “coupling” and “connection” should be broadly understood as, for example, fixed connection, detachable connection, or integral connection; or mechanical connection, electrical connection or intercommunication; or direct connection, or indirect connection via an intermediary medium; or internal communication between two elements or interaction between two elements. For those skilled in the art, the specific meanings of such terms herein can be construed in light of the specific circumstances. Herein, unless otherwise specified and defined explicitly, if a first feature is “on” or “beneath” a second feature, this can cover direct contact between the first and second features, or contact via another feature therebetween, other than the direct contact. Furthermore, if a first feature is “on”, “above”, or “over” a second feature, this can cover the case that the first feature is right above or obliquely above the second feature, or just indicate that the level of the first feature is higher than that of the second feature. If a first feature is “beneath”, “below”, or “under” a second feature, this can cover the case that the first feature is right below or obliquely below the second feature, or just indicate that the level of the first feature is lower than that of the second feature.

The disclosure below provides many different embodiments or examples so as to realize different structures described herein. In order to simplify the disclosure herein, the following will give the description of the parts and arrangements embodied in specific examples. Of course, they are only for the exemplary purpose, not intended to limit the present disclosure. Besides, the present disclosure can repeat a reference number and/or reference letter in different examples, and such repeat is for the purpose of simplification and clarity, which does not represent any relation among various embodiments and/or arrangements as discussed. In addition, the present disclosure provides examples of various specific processes and materials, but those skilled in the art can also be aware of application of other processes and/or use of other materials.

The preferred embodiments of the present disclosure will be described below with reference to the drawings. It should be appreciated that the preferred embodiments described here are only for the purpose of illustrating and explaining, instead of limiting, the present disclosure.

This disclosure provides a LiDAR, which can obtain a point cloud of LiDAR with higher line number and flexibly adjustable angular resolution, improving long-range detection capability. The details are as follows.

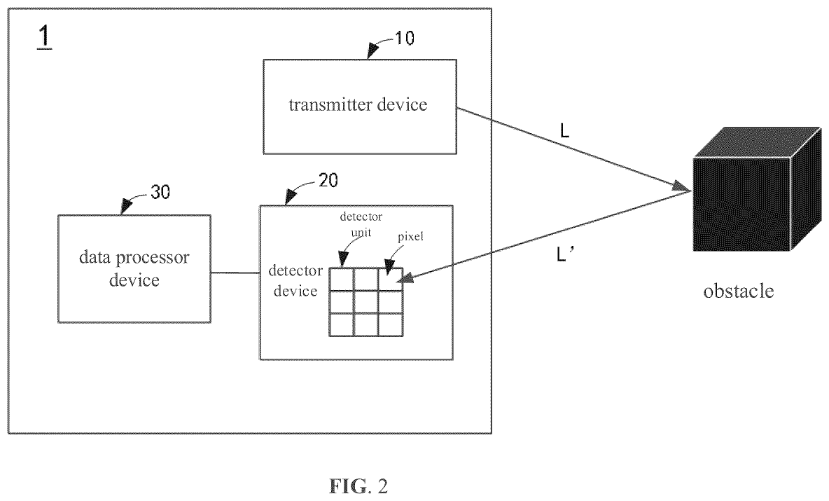

FIG. 2 is a schematic diagram illustrating a LiDAR 1 consistent with some embodiments of this disclosure. As shown in FIG. 2, the LiDAR 1 includes a transmitter device 10, a detector device 20, and a data processor device 30. The transmitter device 10 can transmit a detection light beam L for detecting an object (e.g., a cube as illustrated in FIG. 2). The detector device 20 includes a plurality of detector units (FIG. 2 exemplarily illustrates a detector unit). Each of the detector units includes a pixel array, such as a 3×3 pixel array as exemplarily illustrated in FIG. 2. Each pixel can respond to an echo L of the detection light beam L reflected from the object and convert the echo into an electrical signal. The data processor device 30 is coupled to the detector device 20. The data processor device 30 can reconstruct electrical signals output by the pixel array of the detector unit to obtain a reconstructed signal array and generate a point cloud of LiDAR based on the reconstructed signal array for at least one of the detector units. Each signal in the reconstructed signal array can be obtained based on electrical signals output by a plurality of adjacent pixels. In this disclosure, for at least one of the detector units, the point cloud of LiDAR is not generated based on original electrical signals from the pixel array of the detector units. But a reconstructed signal array can be obtained based on reconstructing on the basis of the original electrical signals, and the point cloud of LiDAR can be generated based on the reconstructed signal array. The signal intensity in the reconstructed signal array can be improved, which can improve the detection capability of the detector unit.

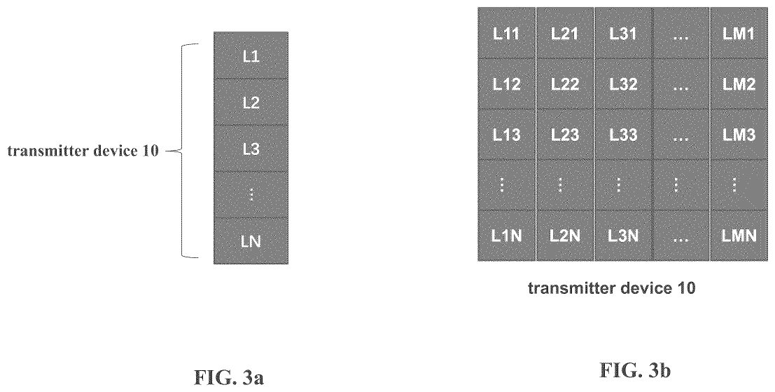

FIG. 3a is a schematic diagram illustrating the transmitter device 10 consistent with some embodiments of this disclosure. As shown in FIG. 3a, the transmitter device 10 includes a plurality of transmitter units, such as N transmitter units L1, L2, L3, . . . , LN as exemplarily illustrated in FIG. 3a, where N is an integer greater than or equal to 1. The plurality of transmitter units form a line array of transmitter units.

It should be noted that the transmitter device 10 is not limited to including only one single column of transmitter units. In some embodiments of this disclosure, the transmitter device 10 can also include multiple columns of transmitter units. The multiple columns of transmitter units are coupled in parallel to form an area array of transmitter units, such as a N×M area array of transmitter units as exemplarily illustrated in FIG. 3b, where N and M are integers greater than 1.

The specific type of the transmitter unit is not limited in this disclosure. In some embodiments, the transmitter unit can be a vertical-cavity surface-emitting laser (VCSEL) or an edge-emitting laser (EEL), which can be selected as needed. During the detection process, the transmitter units can transmit light sequentially at a certain angular resolution (e.g., 0.05°, 0.1°, 0.4°, etc.) in vertical and/or horizontal direction, which can enable the LiDAR to detect in a certain field of view.

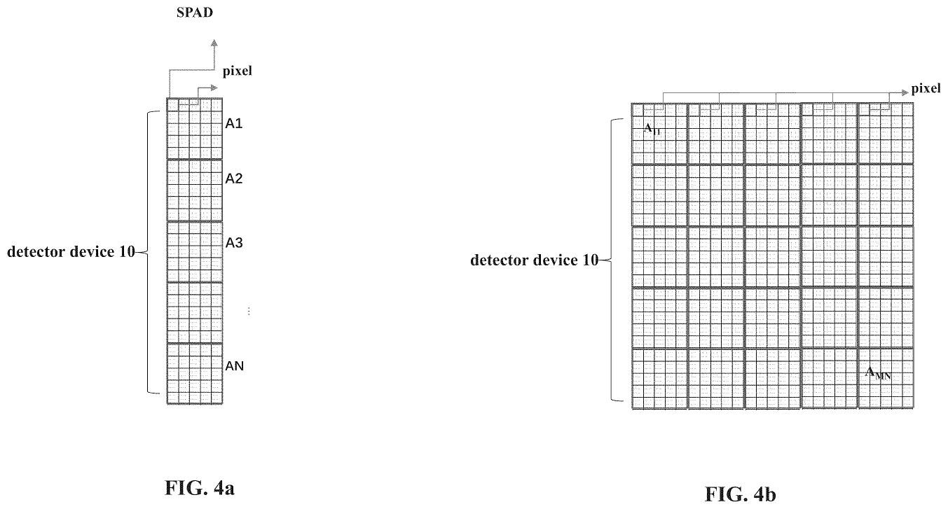

FIG. 4a is a schematic diagram illustrating the detector device 20 consistent with some embodiments of this disclosure. As shown in FIG. 4a, the detector device 20 includes a plurality of detector units, such as N detector units A1, A2, A3, . . . , AN as exemplarily illustrated in FIG. 4a, where N is an integer greater than or equal to 1. The plurality of detector units form a line array of detector units.

The above embodiments describe the case where the detector device 20 includes a single column of detector units. Besides, in some embodiments of this disclosure, the detector device 20 can also include multiple columns of detector units, which are coupled in parallel to form an area array of detector units, such as a N×M area array of detector units as exemplarily illustrated in FIG. 4b, where N and M are integers greater than 1.

Referring to FIG. 4a or FIG. 4b, each detector unit includes a plurality of pixels. The plurality of pixels form a pixel array, as exemplarily illustrated in FIG. 4a or FIG. 4b. Each of the detector units includes a 5×5 pixel array. In some embodiments, each pixel includes a plurality of single-photon avalanche diodes (SPADs). As illustrated in FIG. 4a or FIG. 4b, each pixel includes 3×3 (i.e., 9) SPADs. Each SPAD can be independently gated and addressed. That is to say, each SPAD can independently respond to the echo L′ of the detection light beam L reflected from the object and convert the echo into an electric signal. The number of pixels included in each detector unit and the number of SPADs included in each pixel are not limited in this disclosure.

In some embodiments, a signal output of a pixel can be obtained based on the electrical signals output by a plurality of SPADs on a pixel. For example, a signal output of a pixel can be obtained by accumulating the electrical signals output by nine SPADs on a pixel. Similarly, a signal output of a detector unit can also be obtained based on electrical signals output by a pixel array of a detector unit. For example, the signal output of a detector unit can be obtained by accumulating the electrical signals output by the pixel array of the detector unit.

In some embodiments, a transmitter unit in the transmitter device 10 corresponds to a detector unit in the detector device 20. Each detector unit can be independently gated and addressed. For example, when a transmitter unit transmits a detection light beam, a detector unit corresponding thereto responds while the other detector units remain turned off.

In one embodiment of this disclosure, for the at least one of the detector units, the data processor device 30 does not reconstruct electrical signals from part of pixels in the pixel array, but traverses electrical signals output by the pixel array of the detector unit and reconstructs electrical signals output by the pixel array of the detector unit to obtain the reconstructed signal array. By obtaining the reconstructed signal array through traversing and reconstruction, the intensity of the output signal can be significantly increased, which is beneficial for improving the detection capability of the detector unit.

Reconstruction methods based on different embodiments of this disclosure will be described as follows.

In some embodiments, the data processor device 30 obtains the reconstructed signal array by convoluting the electrical signals output by the pixel array. For example, the electrical signals output by the pixel array of the detector unit can be reconstructed using a convolution kernel and a predetermined convolution stride, to obtain the reconstructed signal array. The convolution kernel is an accumulation window. The window height H and width W of the convolution kernel can be configured. At least one of H and W is of a value greater than one pixel, and they can be equal or unequal. In some embodiments, for example, the window height H and width W of the convolution kernel are equal, such as 3 pixels in size, where the size of each pixel is 30 um×30 um. In other words, the size of the convolution kernel is a 3×3 matrix (such as, 90 um×90 um). It should be noted that this embodiment is only illustrative, it shall not be considered as limitation to this disclosure, and the size of the convolution kernel can be different depending on actual situations.

The convolution stride refers to a translation stride of the convolution kernel. The convolution stride includes a horizontal stride Hs (Hstride) in the horizontal direction and a vertical stride Vs (Vstride) in the vertical direction, both of which can be flexibly configured. The values of both horizontal stride Hs and the vertical stride Vs are greater than or equal to 1, and they can be equal or unequal. In some embodiments, the values of the horizontal stride Hs and the vertical stride Vs can be equal. The minimum horizontal stride Hs/vertical stride Vs can be one pixel in size.

In addition, convolution of the electrical signals output by the pixel array of the detector unit is actually a data accumulation of the electrical signals (such as echo waveforms) output by the pixel array of the detector unit, which can obtain the reconstructed signal array (also referred to as a reconstructed pixel array) on the detector unit. Subsequently, a distance and/or reflectivity of object can be calculated based on each reconstructed signal. The specific process is described as follows.

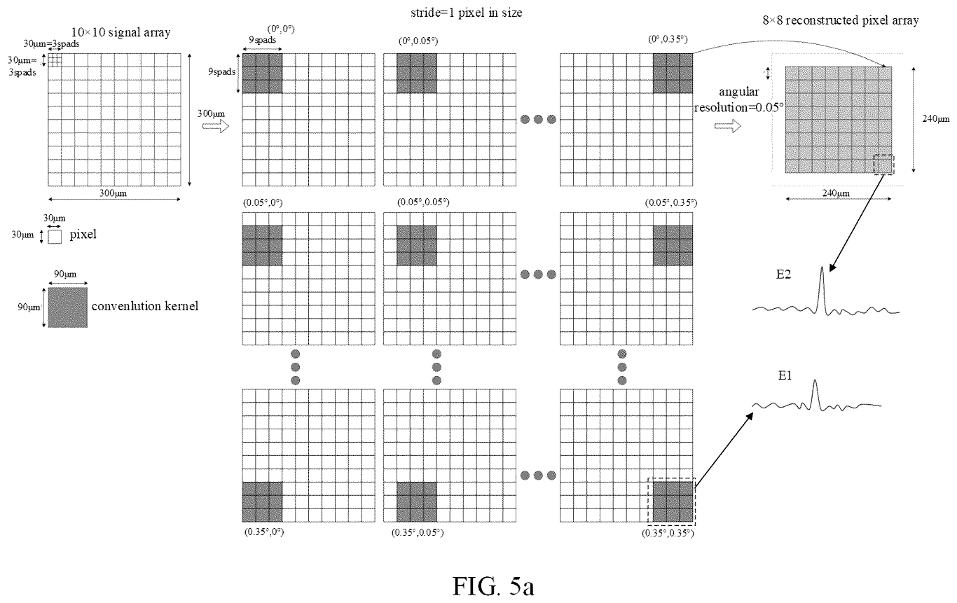

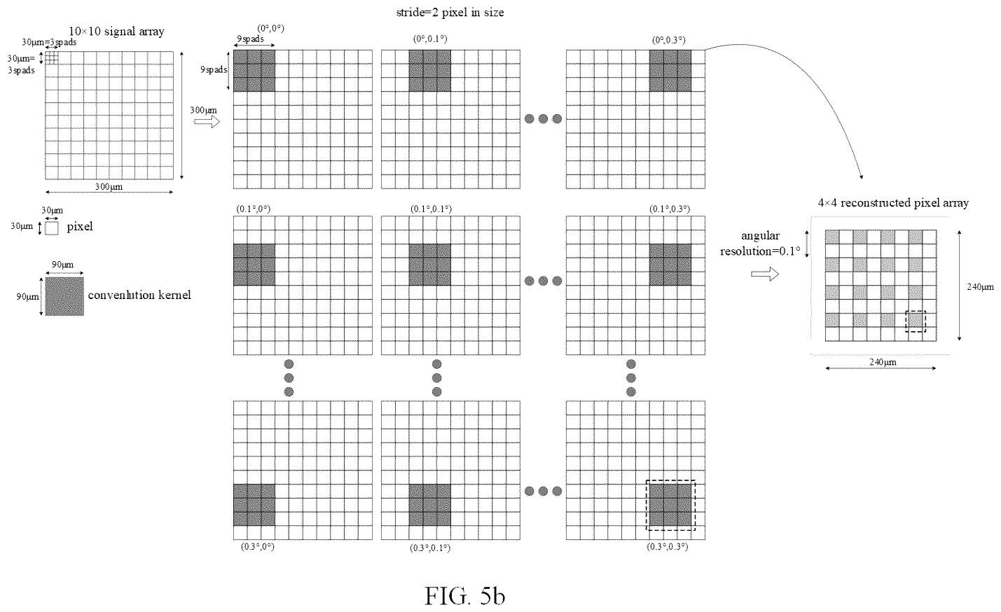

FIG. 5a is a schematic diagram illustrating a process of obtaining the reconstructed signal array by performing convolution on the electrical signals output by the pixel array of the detector unit consistent with some embodiments of this disclosure. The left part of FIG. 5a illustrates a situation of the pixel array of the detector unit before the convolution processing. The middle part of FIG. 5 illustrates a process of performing convolution on the pixel array of the detector unit. The right part illustrates a situation of the pixel array of the detector unit after the convolution processing.

As shown in the left part of FIG. 5a, the size of the detector unit can be, for example, 300 um×300 um. The detector unit includes a 10×10 pixel array. The size of each pixel is 30 um×30 um. Each pixel can include nine single photon avalanche diodes (SPADs). The nine SPADs form a 3×3 SPAD array. The size of each SPAD is 10 um×10 um. In addition, the size of the convolution kernel in both horizontal and vertical directions can be three pixels in size, i.e., 90 um×90 um, which is also the size of a 9×9 SPAD array. Of course, the size of the convolution kernel in both the horizontal and vertical directions can also be varied depending on actual situations. The convolution strides in both the horizontal and vertical directions can be the side length of one pixel, i.e., 30 um, which is the size of 3 SPADs.

As shown in the middle part of FIG. 5a, during the convolution process, the electrical signals (e.g., echo waveforms) output by pixels (e.g., 9 pixels) corresponding to the convolution kernel are directly accumulated or weighted accumulated using the convolution kernel (e.g., nine pixels in size, that is 90 um×90 um) and a predetermined convolution stride (such as one pixel in size). The reconstructed signal of pixels corresponding to the convolution kernel can be obtained (also called a reconstructed pixel, indicated by dashed box in the right part of FIG. 5a). By traversing the entire pixel array (e.g., 10×10) on the detector unit, the reconstructed signal array of the pixel array (e.g., 10×10) on the detector unit can be obtained, such as, an 8×8 pixel array as shown in the right part of FIG. 5 (as shown in the middle part of FIG. 5a, a convolution is performed by taking the pixel in the 2nd row and 2nd column as a center and then a reconstructed pixel in the 1st row and 1st column as shown in the right part of FIG. 5a is generated. The stride in the horizontal direction is one pixel. . . . A convolution is performed by taking the pixel in the 2nd row and 9th column as the center and then a reconstructed pixel in the 1st row and 8th column as shown in the right part of FIG. 5a is generated. The stride in the vertical direction is one pixel. A convolution is performed by taking the pixel in the 9th row and 2nd column as the center and then a reconstructed pixel in the 8th row and 1st column as shown in the right part of FIG. 5a is generated. After traversing the entire 10×10 pixel array, an 8×8 reconstructed pixel array is obtained). Subsequently, the distance to the object and/or the reflectivity of the object can be calculated based on each reconstructed signal in the reconstructed signal array. In addition, it can be clearly seen from the right part of FIG. 5a that the dimensions of the reconstructed pixel array are 240 um×240 um, which are smaller than the dimensions of the pixel array (which is 300 um×300 um) before performing reconstruction.

In addition, FIG. 5a also illustrates two echoes E1 and E2. The echo E1 is an echo of one pixel in the pixel array of the detector unit before convolution processing. The echo E2 is an echo of one reconstructed pixel in the pixel array of the detector unit after convolution processing, that is, a reconstructed signal. The reconstructed pixels are equivalent to the direct/weighted accumulation of the adjacent pixels (e.g., nine pixels) corresponding to the convolution kernel. The signal intensity of the echo E2 of the reconstructed pixel (e.g., reconstructed signal) is significantly stronger than the signal intensity of the echo E1 of the pixel before reconstruction (the accumulation result of a time window is illustrated in the drawings). For example, a single SPAD can only output a signal of 0 or 1, which is easily saturated. The number of SPADs contained in a single pixel is still not enough to obtain a strong long-range measurement signal. By accumulating the signals output by a plurality of pixels covered by the convolution kernel, the peak part can be accumulated within a time window. After convolution processing, the signal intensity of the signals output by the reconstructed signal array on the detector unit can be significantly improved, which is beneficial for improving the detection capability of the detector unit.

In addition, those skilled in the art would understand that in FIG. 5a, at each detection moment, the output of each pixel in the pixel array (10×10 matrix) on the detector unit corresponds to a numerical value, such as 0, 1 or other values, which represents intensity of a corresponding echo at the pixel, such as the intensity of echo El in the drawings. After the convolution processing mentioned above, the reconstructed signal array (reconstructed pixel array) is generated, where each element also corresponds to a numerical value representing the intensity of the reconstructed signal, such as the intensity of echo E2.

FIG. 5 illustrates that the size of the detector unit is 300 um×300 um, which includes a 10×10 pixel array. The sizes of the convolution kernel in both the horizontal and vertical directions are 3 pixels in size, which is 90 um×90 um. The size of the convolution kernel can also be larger. For example, the size in the horizontal and vertical directions are both 4 pixels in size, which is 120 um×120 um. In this case, the intensity of the echo can be larger. Correspondingly, the field of view (FOV) corresponding to each reconstructed pixel will also be larger, which is not beneficial for detecting small objects. For example, when the horizontal and vertical fields of view corresponding to each pixel are both 0.05°, the horizontal and vertical fields of view corresponding to the reconstructed pixel as generated are both 0.15° when using a convolution kernel with a size of 3 pixels in horizontal direction and vertical direction. When a convolution kernel with a size of 4 pixels in horizontal direction and vertical direction is used, the horizontal and vertical fields of view corresponding to the reconstructed pixels as generated are both 0.2°. The size of the convolution kernel, detector unit and pixels will be selected based on the actual application.

The above embodiments describe in detail the process of perform convolution on the electrical signals output by the pixel array of the detector unit to obtain the reconstructed signal array when the convolution stride is one pixel as an example. Next, the process of performing convolution on the electrical signals output by the pixel array of the detector unit to obtain the reconstructed signal array will be described by taking two pixels as the convolution stride.

FIG. 5b is a schematic diagram illustrating the process of performing convolution on the electrical signals output by the pixel array of the detector unit to obtain a reconstructed signal array consistent with some embodiments of this disclosure. The left part of FIG. 5b illustrates the situation of the pixel array of the detector unit before convolution processing. The middle part illustrates the process of perform convolution on the pixel array of the detector unit. The right part illustrates the situation of the pixel array of the detector unit after convolution processing.

The situation of the pixel array of the detector unit before convolution processing is similar to that in the previous embodiments.

In the process of performing convolution on the pixel array of the detector unit, as shown in the middle part of FIG. 5b, the electrical signals (e.g., echo waveforms) output by the pixels (e.g., 9 pixels) corresponding to the convolution kernel are directly accumulated or weighted accumulated using the convolution kernel (e.g. nine pixels in size, that is 90 um×90 um) and a predetermined convolution stride (such as two pixels in size). The reconstructed pixel of pixels corresponding to the convolution kernel can be obtained (indicated by dashed box in the right part of FIG. 5b). By traversing the entire pixel array (e.g., 10×10) on the detector unit, the reconstructed signal array of the pixel array (e.g., 10×10) on the detector unit can be obtained, such as, a 4×4 pixel array as shown in the right part of FIG. 5b. Subsequently, the distance to the object and/or the reflectivity of objects can be calculated based on each reconstructed signal in the reconstructed signal array. In addition, it can be clearly seen from the right part of FIG. 5b that the size of the reconstructed pixel array is 240 um×240 um, which is smaller than the size of the pixel array (which is 300 um×300 um) before performing reconstruction. In this embodiment, the field angles of view of the detector unit in horizontal direction and vertical direction are 0.1°×0.1° respectively. Although not shown in FIG. 5b, it should be understood that the signal intensity of the signal output by the reconstructed signal array on the detector unit after convolution processing also increases significantly, which is beneficial for improving long-range detection capability of the LiDAR.

The above embodiments describe the process of performing convolution on the electrical signals output by the pixel array of the detector unit to obtain the reconstructed signal array, with the convolution stride (horizontal/vertical) of one pixel and two pixels as examples. By comparing FIG. 5a and FIG. 5b, it can be seen that in the process of performing convolution on the 10×10pixel array of the detector unit, when the convolution stride is one pixel, a 8×8 reconstructed signal array can be obtained. The distance between adjacent reconstructed signals is one pixel. The resolution of the point cloud of LiDAR is 0.05°×0.05°. When the convolution stride is two pixels, a 4×4 reconstructed signal array can be obtained. The distance between adjacent reconstructed signals is two pixels. The resolution of the point cloud of LiDAR is 0.1°×0.1°. The convolution stride ultimately reflects the size of the reconstructed signal array after convolution processing. The size of the reconstructed signal array after convolution processing is inversely proportional to the convolution stride. That is, the larger the convolution stride is, the smaller the size of the reconstructed signal array after convolution processing is. In addition, the angular resolution of the point cloud of LiDAR after convolution processing is also inversely proportional to the convolution stride. That is, the smaller the convolution stride is, the higher the angular resolution of the point cloud of LiDAR after convolution processing is and the better the quality of the point cloud of LiDAR is. It is easier to show the details of the detected objects. The size of the convolution stride can be flexibly adjusted based on the actual situation, which can achieve a flexible configuration of the resolution of the point cloud of LiDAR.

In some embodiments, the convolution stride can be adjusted based on the field of view corresponding to the detector unit. In other words, different convolution strides can be used for the detector units corresponding to different fields of view, and the specific description is as follows. In some embodiments, the output signals of all the detector units can be reconstructed as above, which can impose higher requirements on the data processing capacity and processing speed of the LiDAR. In some embodiments, the output signals of detector units corresponding to a particular field of view can be reconstructed as above. The particular field of view can be, for example, a central area of the field of view of the LiDAR, which is typically the most important area to be focused on. The data processor device 30 can reconstruct the electrical signals output by the pixel array of at least one detector unit corresponding to the particular field of view to obtain the reconstructed signal array, and generate a point cloud of LiDAR based on the reconstructed signal array. The reconstructed signal array is equivalent to accumulation of adjacent pixels. The signal intensity of the point cloud of LiDAR generated based on the reconstructed signal array can also be significantly improved, which is beneficial for improving the long-range detection capability of the LiDAR. In some embodiments, an image identification method can be used to determine the particular field of view of the LiDAR. For example, the LiDAR can cooperate with a camera. In the images captured by the camera, some objects that need to be focused on can be identified, such as pedestrians, vehicles and so on. For the identified object, a field of view of the LiDAR corresponding to the identified object and the corresponding detector units can be determined., Data processing is performed on the output signal of these detector units through the above reconstruction.

For fields of view outside the particular field of view of the LiDAR, such as a marginal area of the field of view of the LiDAR, the data processor device 30 can generate a point cloud of LiDAR based on electrical signals output by a pixel array of a detector unit corresponding to the field of view outside the particular field of view, instead of reconstructing electrical signals output by the detector unit. The power consumption and processing load of LiDAR can be effectively reduced. It should be noted that the particular field of view is not necessarily the central area of the field of view of the LiDAR, but can be any other area of the field of view of the LiDAR, which can be set based on actual needs, and which will not be limited in this disclosure.

Furthermore, in some embodiments of this disclosure, different convolution strides can be used for different areas. For example, the first detector unit and the second detector unit in the detector device are preferably two detector units with the same configuration, that is, their sizes, the number and size of pixels therein, and the number and size of single-photon avalanche diodes (SPADs) are the same. The two detector units correspond to different field of view and can use different convolution strides as needed. For example, the size of both the first detector unit and the second detector unit is 300 um×300 um and include a 10×10 pixel array. The size of each pixel is 30 um×30 um and each pixel includes nine single-photon avalanche diodes (SPADs). The nine single-photon avalanche diodes (SPADs) form a 3×3 single-photon avalanche diode (SPAD) array. The size of each single-photon avalanche diode (SPAD) is 10 um×10 um. It should be understood that the configurations of the first detector unit and the second detector unit in this embodiment are only illustrative, which do not form limitation to this disclosure. The data processor device 30 can reconstruct the electrical signals output by the pixel array of the first detector unit to obtain a first reconstructed signal array, and generate m points in the point cloud of LiDAR based on the first reconstructed signal array. Similarly, the data processor device 30 can reconstruct the electrical signals output by the pixel array of the second detector unit to obtain a second reconstructed signal array, and generate n points in the point cloud of LiDAR based on the second reconstructed signal array, where m is greater than n. For example, FIG. 6 illustrates the reconstructed arrays of signals obtained by reconstructing the arrays of pixels of the two first detector units and two second detector units in this way. The field of view of the first detector units correspond to a central area of the field of view of the LiDAR. The field of view of the second detector units correspond to an area outside the central area. The LiDAR typically pays more attention to the central area of its field of view during detection. When the first detector unit is assigned to the central region of the field of view, a denser point cloud of LiDAR can be generated (as shown in FIG. 6, the reconstructed signal array in the central area is a 8×8 array), which can provide more refined representation of the detected target, and improve detection effectiveness and reliability, especially for long-range objects. For the second detector unit corresponding to an area near the margin of the field of view, a larger convolution stride can be used to generate a sparser point cloud of LiDAR (as shown in FIG. 6, a reconstructed signal array for the marginal area is a 4×4 array). Furthermore, in some embodiments, an area outside the central area of the field of view of the LiDAR can be set as low priority. The second detector unit can be used to detect the area outside the central area of the field of view, which can achieve a balance between effective and reliable detection results and processing efficiency to some extent. It can be clearly seen from FIG. 6 that the point cloud of LiDAR generated based on the first reconstructed signal array is denser. The point cloud of LiDAR generated based on the second reconstructed signal array is sparser. The dark grids represent points in the point cloud of LiDAR at corresponding spatial positions. It should be noted that FIG. 6 illustrates the reconstructed arrays of signals obtained by reconstructing the arrays of pixels of two first detector units and two second detector units. It is only illustrative, which shall not be considered as limitation to this disclosure. In actual processing, different number of first detector units and second detector units can also be reconstructed. There all fall within the scope of protection of this disclosure.

In the above embodiments, the convolution stride of the central area of the field of view of the LiDAR can be adjusted to be smaller than that of the marginal area of the field of view. For example, a smaller convolution stride (e.g., one pixel in size) can be set for the central area of the field of view of the LiDAR. A larger convolution stride (e.g., two pixels in size) can be set for the marginal area of the field of view. The distribution of the point cloud of LiDAR can change from a distribution with uniform resolution to a distribution with a denser distribution in the central area and a sparser distribution in the edge area. As exemplarily illustrated in FIG. 6, in the point cloud of LiDAR, the resolution of the central area of the field of view (indicated by a horizontal angle) is 0.05°×0.05°. The resolution of the marginal area of the field of view is 0.1°×0.1°.

In some embodiments, the data processor device 30 can further obtain a ROI around the LiDAR, and set the detector unit corresponding to the ROI as the at least one of the detector units, signal for which will be reconstructed. The ROI refers to a region of interest, which can be set based on user's needs and/or interests. Optionally, image identification methods can be used to determine the ROI. After setting a ROI, at least one detector unit corresponding to the ROI can be set based on the size and/or shape of the ROI. Optionally, a plurality of detector units can be set to obtain a larger detection area. Signal intensity of outputting signals can be higher, which can improve the quality of the point cloud of LiDAR, and improve the effectiveness and reliability of the detection results in the ROI. Furthermore, the ROI can also be set in the central area of the field of view of LiDAR, which can improve the effectiveness and reliability of the detection results as well.

In addition, the convolution stride can also be set based on the ROI around the LiDAR. For example, a smaller convolution stride (e.g., 1 pixel in size) can be used for the ROI around the LiDAR. A larger convolution stride (e.g., 2 pixels in size) can be used for the non-ROI. It should be understood that these embodiments are only illustrative, which shall not be considered as limitation to this disclosure.

In some embodiments, the convolution stride can also be adjusted based on the density of the point cloud of LiDAR. For example, a smaller stride (e.g., 1 pixel in size) can be used for dense areas in the point cloud of LiDAR. A larger convolution stride (e.g., 2 pixels in size) can be used for sparse areas (non-dense area).

The above embodiments describe adjusting the convolution stride based on the field of view corresponding to the detector unit. By adjusting the convolution stride, the resolution of the point cloud of LiDAR can be flexibly configured, which not only allows for obtaining the point cloud of LiDAR with desired resolution but also reduces resource consumption.

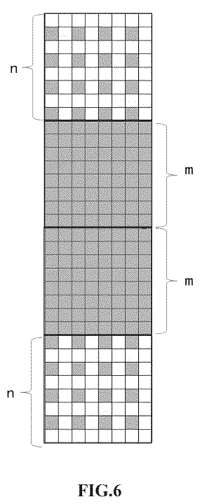

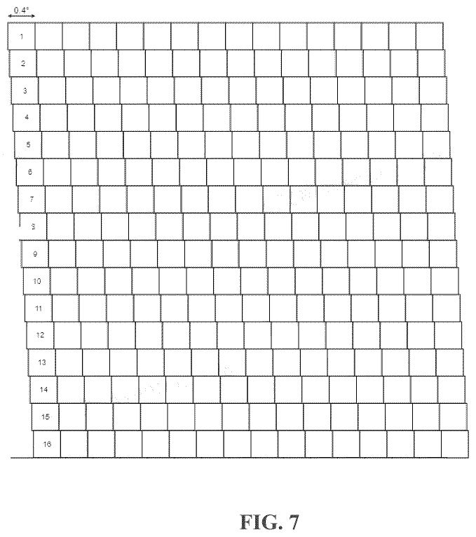

FIG. 7 is a schematic diagram illustrating the operating mode of the detector unit consistent with some embodiments of this disclosure. In some embodiments, the operating mode of the detector unit can be described as follows. For vertical scanning, traverse can be performed by scanning pixels one by one. For example, each transmitter unit can sequentially transmit light with a certain interval of FOV angle (e.g.,) 0.4°. The size of a light spot of the detection light beam transmitted by a transmitter unit is approximately the same as that of a detector unit. A corresponding detector unit can respond. The detected electrical signal can be converted by an analog-to-digital conversion chip such as an analog-to-digital converter (ADC) or a time-to-digital converter (TDC) and is then processed by a digital processing chip to identify the echo and measure the time of flight. This enables detection of the field of view in vertical direction, which belongs to electronic scanning. For horizontal scanning, the transmitter unit can be driven to scan from one side of the field of view of the LiDAR to the other side by mechanical rotation mechanism such as scanning device deflection and rotor rotation, which enable detection of horizontal field of view, which belongs to mechanical scanning. In the figures, since the vertical scanning and horizontal scanning are synchronized, there is a certain offset in the horizontal angles corresponding to a column of detector units.

In some embodiments, the detector device 20 can be implemented by a detection chip that performs Time-of-Flight (TOF) measurement. FIG. 8 is a schematic diagram illustrating a detection chip in some embodiments of this disclosure. As shown in the left part of FIG. 8, the detection chip is integrated with a plurality of independent detector units (FIG. 8 exemplarily illustrates one of the detector units, please refer to sections indicated by the small white square). Each detector unit includes a pixel array. The right part of FIG. 8 is an enlarged view of one detector unit. The size of the detector unit can be 300 um×300 um and the detector unit can include a 10×10 pixel array. Each pixel can include a 3×3 area array of single-photon avalanche diodes (SPAD).

In some embodiments, the transmitter device includes a plurality of transmitter units. The number of rows in the reconstructed signal array is greater than the number of transmitter units. For example, for one transmitter unit, the reconstructed pixel array based on this disclosure includes a plurality of rows, such as the aforementioned 8 rows or 4 rows. That is, one transmitter unit eventually forms 8 lines or 4 lines. The numbers of detector units and transmitter units of LiDAR are no longer one-to-one corresponding to the line number of LiDAR as described in the background. The line number is much higher than the numbers of transmitter units and detector units. The technical solution of this disclosure greatly increases the line number of LiDAR.

In some embodiments, the dimension of the reconstructed signal array is smaller than the dimension of the pixel array. Referring again to FIG. 5a, for example, the dimension of the reconstructed signal array is 8. The dimension of the pixel array is 10. As shown in FIG. 5b, the dimension of the reconstructed signal array is 4. The dimension of the pixel array is 10. It can be seen that the dimension of the reconstructed signal array is smaller than the dimension of the pixel array.

It should be noted that the line number of the point cloud of LiDAR generated by the technical solution of this disclosure can be unequal to the number of the transmitter units/detector units. The line number can be much higher than the number of the transmitter units/detector units. A point cloud of LiDAR with higher line number can be obtained.

In some embodiments of this disclosure, a point cloud of LiDAR with 256 lines can be obtained based on 32 transmitter units and 32 detector units. For example, the 32 transmitter units and 32 detector units are distributed vertically. When a convolution stride is 1 pixel, traverse can be performed to obtain a point cloud with 256 rows (32×8=256)×8 columns. A point cloud array of 256×8 can be obtained, which is equivalent to a LiDAR with 256 lines. LiDAR with more than 256 lines is similar to the LiDAR with 256 lines.

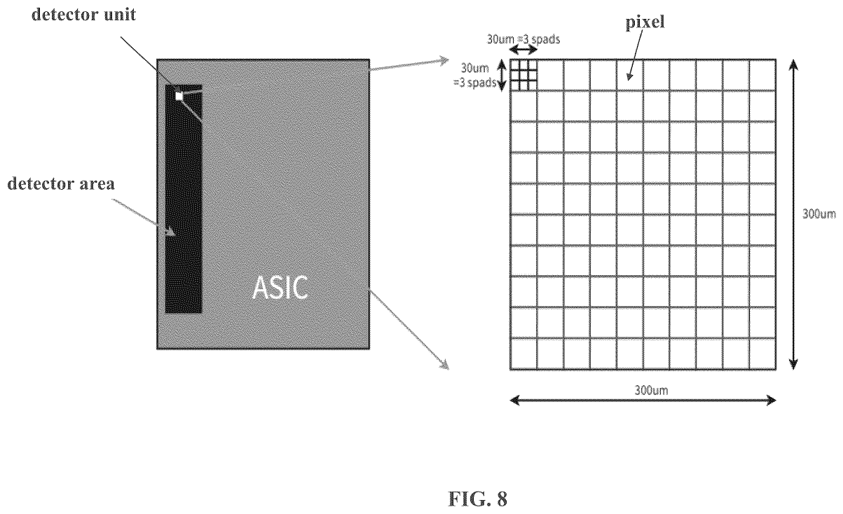

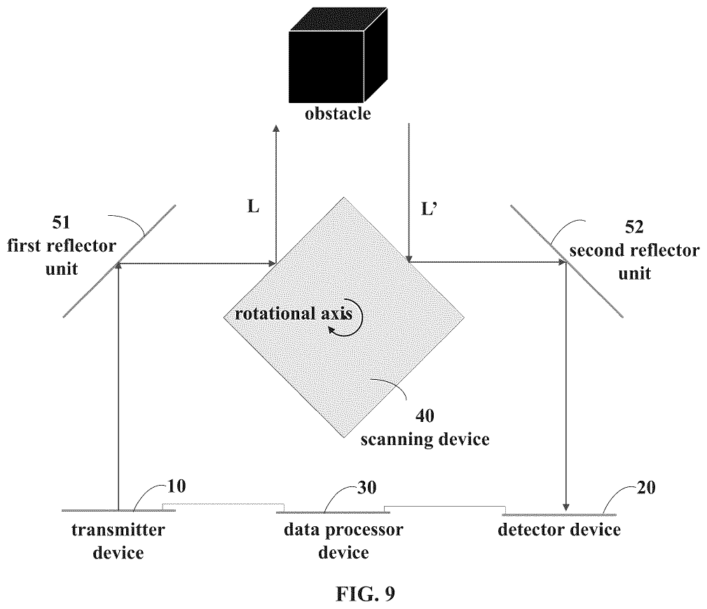

In some embodiments of this disclosure, the LiDAR can be a scanning LiDAR. As shown in FIG. 9, in addition to the transmitter device 10, the detector device 20 and the data processor device 30, the LiDAR further includes a scanning device 40, a first reflector unit 51 and a second reflector unit 52. The scanning device 40 can be any one of a rotating mirror, a galvanometer and a swinging mirror. The first reflector unit 51 and the second reflector unit 52 can be reflectors.

In some embodiments of this disclosure, the scanning device is a multi-faceted rotating mirror. During the detection process of the LiDAR, the transmitter device 10 and the detector device 20 remain stationary. A detection light beam L is transmitted by the transmitter device 10 and reflected from the first reflector unit 51. The reflected detection light beam passes by one facet of the scanning device 40 and is emitted into the external space. An echo L′is generated after the detection light beam L is reflected rom objects in the external space and then incident in another facet of the scanning device 40, and then is received by the detector unit on the detector device after being reflected from the second reflector unit 52. By rotating the scanning device 40 around the rotation axis, detection within a certain field of view in the horizontal direction can be achieved.

In some embodiments, the scanning device 40 can be implemented by a one-dimensional scanning device or a two-dimensional scanning device. For a LiDAR using a one-dimensional scanning device, the transmitting direction of each transmitter unit corresponds to a field of view or an angle in horizontal/vertical direction. Different transmitter units correspond to different fields of view or angles. Detection within a certain field of view in the horizontal/vertical direction can be achieved. For example, in the detection process of LiDAR, the one-dimensional scanning device rotates around the rotation axis. When the rotation axis is in vertical direction, the one-dimensional scanning device can deflect the detection light beam transmitted by the transmitter unit to different angles in the horizontal direction through rotation, which can realize scanning detection of a certain field of view in the horizontal direction. Combining the detection in the horizontal direction with the detection of the transmitter unit in the vertical direction, three-dimensional detection of the surrounding environment can be achieved. Conversely, when the rotation axis is in horizontal direction, the one-dimensional scanning device can deflect the detection light beam transmitted by the transmitter unit to different angles in the vertical direction through rotation, which can realize scanning detection within a certain field of view in the vertical direction. Combining the detection in the vertical direction with the horizontal detection of the transmitter unit, three-dimensional detection of the surrounding environment can be achieved.

For a LiDAR using a two-dimensional scanning device, the scanning device 40 has two rotation axes that are at a certain angle (e.g.,) 90°. The scanning device 40 can reflect the detection light beams transmitted by the transmitter unit to different angles in two directions (e.g., horizontal and vertical directions), which can achieve two-dimensional scanning. In some embodiments, the two-dimensional scanning device can include two one-dimensional scanning devices. The rotation axes of the two one-dimensional scanning devices are at a certain angle (e.g.,) 90°, which can achieve two-dimensional scanning.

The above describes the scanning LiDAR. In some embodiment of this disclosure, the LiDAR can also be a mechanical LiDAR. In addition to the transmitter device 10, detector device 20 and data processor device 30, the mechanical LiDAR further includes an opto-mechanical rotor (not shown in the drawings). The transmitter device 10 and the detector device 20 are arranged on the opto-mechanical rotor. At least one transmitter unit of the transmitter device 10 corresponds to at least one detector unit of the detector device 20. In the detection process, the transmitting direction of each transmitter unit corresponds to a field of view or an angle in the vertical direction. Different transmitter units correspond to different fields of view or angles in the vertical direction. The scanning detection of a certain field of view of the LiDAR in the vertical direction can be realized. The opto-mechanical rotor rotates around a vertical axis. The LiDAR can perform 360° scanning and detection in the horizontal direction. During the rotation of the opto-mechanical rotor, the transmitter device transmits a detection light beam L every certain rotation angle (i.e., the horizontal angular resolution of the LiDAR, such as 0.05°, 0.1°, etc.). The detector device 20 receives the echo L′ generated after the detection light beam is diffusely reflected on objects. The data processor device 30 can reconstruct based on the electric signals output by the pixel array of the detector unit to obtain a reconstructed signal array. The point cloud of LiDAR with desired resolution can be generated based on the reconstructed signal array.

In some embodiments of this disclosure, the LiDAR can also be a completely solid-state LiDAR, preferably a LiDAR of area array. In the detection process, a transmitter unit illuminates a detector unit. A detector unit is powered on, while the other detector units are powered off. In some embodiments, the transmitter units and the detector units are arranged in an area array, as shown in FIGS. 3b and 4b. The detector units are powered on to perform detection based on the transmitting sequence of the corresponding transmitter units, and convolution is performed correspondingly. Suitable convolution kernels and convolution strides can be selected as needed. The data processor device 30 reconstructs the electric signals output by the pixel array of the detector unit to obtain a reconstructed signal array. A point cloud of LiDAR with a desired resolution can be generated based on the reconstructed signal array. Compared with the scanning or mechanical LiDARs, the solid-state LiDAR does not include a scanning device 40 or an opto-mechanical rotor. The size of the LiDAR can be further reduced, which is beneficial for miniaturization of the LiDAR.

The LiDAR of this disclosure is specifically described as above. By using the LiDAR of this disclosure, full scene scanning of surroundings of the LiDAR can be achieved by carrying out exposure on a limited field of view each time (i.e., time-of-flight TOF measurement) and moving the field of view. By stitching the point cloud of LiDARs in respective areas, a point cloud of LiDAR with higher line number and flexible angular resolution can be generated, and the long-range detection capability can be enhanced.

In addition, this disclosure also relates to an integrated light detection and data acquisition and processor device 200. As shown in FIG. 10, the light detection and data acquisition and processor device 200 includes a plurality of detector units 210 and a data acquisition and processor device 220. Among the plurality of detector units 210, each of the detector units includes a pixel array. Each pixel can respond to an echo light signal and convert the echo light signal into an electrical signal. The data acquisition and processor device 220 is coupled to the plurality of detector units 210. The data acquisition and processor device 220 can:

for at least one detector unit, obtain the electrical signals output by the pixel array of the detector unit, reconstruct the electrical signals output by the pixel array of the detector unit to obtain a reconstructed signal array, and

generate a point cloud of LiDAR based on the reconstructed signal array, wherein each signal in the reconstructed signal array can be obtained based on electrical signals output by a plurality of adjacent pixels.

FIG. 11 is a schematic diagram illustrating an integrated light detection and data acquisition and processor device 300 consistent with some embodiments of this disclosure. The data acquisition and processor device 220 includes a digital signal acquiring unit 220-1 and a digital signal processing unit 220-2. The digital signal acquiring unit 220-1 and the digital signal processing unit 220-2 are coupled to each other. The digital signal acquiring unit 220-1 is coupled to a plurality of detector units 210 and can obtain electrical signals output by the pixel array of the plurality of detector units 210. The digital signal processing unit 220-2 can reconstruct the electrical signals obtained by the digital signal acquiring unit 220-1 and obtain a reconstructed signal array, and generate a point cloud of LiDAR with desired resolution based on the reconstructed signal array.

The light detection and data acquisition and processor device 200/300 is described in detail as above. By integrating a plurality of detector units 210 and data acquisition and processor device 220, the integration and miniaturization of the entire device can be achieved, which can improve the convenience when using the entire device.

In addition, this disclosure also relates to a data processing method 100 for a LiDAR. The detector device of the LiDAR includes a plurality of detector units. Each detector unit includes a pixel array. Each pixel can respond to the echo generated after the detection light beam is reflected from an object and convert it into an electrical signal. The data processing method 100 includes steps S101 and S102.

As shown in FIG. 12, in step S101: for at least one of the detector units, reconstructing the electrical signals output by the pixel array of the detector unit to obtain a reconstructed signal array.

In step S102: generating a point cloud of LiDAR based on the reconstructed signal array.

Each signal in the reconstructed signal array can be obtained based on the electrical signals output by a plurality of adjacent pixels.

In some embodiments of this disclosure, each pixel includes a plurality of single-photon avalanche diodes arranged in a matrix. Each single-photon avalanche diode can be independently gated and addressed. In some embodiments of this disclosure, the step S101 includes: for at least one detector unit, traversing the electrical signals output by the pixel array of the detector unit, and reconstructing the electrical signals output by the pixel array of the detector unit to obtain a reconstructed signal array.

In some embodiments of this disclosure, the at least one detector unit corresponds to a particular field of view of the LiDAR. The data processing method 100 further includes: in a field of view outside the particular field of view of the LiDAR, configuring the data processor device to generate a point in the point cloud of LiDAR based on electrical signals output by the pixel array of one detector unit.

In some embodiments of this disclosure, the at least one of the detector units includes a first detector unit and a second detector unit.

The step S101 includes: reconstructing based on the electrical signals output by the pixel array of the first detector unit to obtain a first reconstructed signal array, and reconstructing based on the electrical signals output by the pixel array of the second detector unit to obtain a second reconstructed signal array.

The step S102 includes: generating m points in the point cloud of LiDAR based on the first reconstructed signal array, and generating n points in the point cloud of LiDAR based on the second reconstructed signal array, where m is greater than n.

In some embodiments of this disclosure, the field of view of the first detector unit corresponds to a central area of the field of view of the LiDAR. The field of view of the second detector unit corresponds to an area outside the central area of the field of view of the LiDAR.

In some embodiments of this disclosure, the method further includes:

obtaining a ROI around the LiDAR, and setting the detector unit corresponding to the ROI as the at least one detector unit.

In some embodiments of this disclosure, the step S101 includes:

performing convolution on the electrical signals output by the pixel array of the detector unit using a convolution kernel and a predetermined convolution stride to obtain the reconstructed signal array.

In some embodiments of this disclosure, the convolution stride can be adjusted based on field of view corresponding to the detector unit.

In some embodiments of this disclosure, a convolution stride of a central area of the field of view of the LiDAR is smaller than a convolution stride of a marginal area of the field of view.

In some embodiments of this disclosure, the LiDAR further includes a transmitter device. The transmitter device includes a plurality of transmitter units. The number of rows of the reconstructed signal array is greater than the number of transmitter units.

In some embodiments of this disclosure, a dimension of the reconstructed signal array is smaller than a dimension of the pixel array.

The data processing method 100 for a LiDAR is described as above. Using the data processing method 100 of this disclosure, a point cloud of LiDAR with higher line number and adjustable resolution can be generated, which can improve the accuracy of detection results.

The technical solution of this disclosure has been described as above. Compared with the prior art, the technical solution of this disclosure reconstructs the electrical signals output by the pixel array of the detector unit to obtain a reconstructed signal array with stronger signals. A point cloud of LiDAR with higher line number can be generated based on the reconstructed signal array, improving the long-range detection ability of the LiDAR, which is beneficial for obtaining more effective and reliable detection results. By configuring the convolution stride, the angular resolution of the point cloud of LiDAR can be flexibly adjusted, which can support various configurations including global densification of the point cloud and densification in partial regions of the point cloud. Furthermore, based on the technical solution of this disclosure, the overlap regions of light spots are small, which can improve the utilization rate of photons and reduce the power consumption of the entire device.

This disclosure also provides a computer-readable storage medium including computer-executable instructions stored thereon. When executed by a processor, the executable instructions perform the data processing method 100 described above.

In some embodiments, the computer-readable storage medium can be implemented by any combination of one or more computer-readable media. Examples of computer-readable storage media include, but are not limited to, forms or devices of electric, magnetic, optical, or semiconductor, more specific examples (non-exhaustive lists) include: electrical connections with one or more wires, portable computer hard drives, hard drives, random access memory (RAM), non-volatile random access memory (NVRAM), read-only memory (ROM), erasable programmable read-only memory (EPROM or flash memory), optical fibers, portable compact disc read-only memory (CD-ROM), optical storage devices, magnetic storage devices, or any suitable combination thereof.

Herein, the computer-readable storage media refers to any tangible medium that contains or stores programs that can be used by instruction execution systems, devices, or apparatus or the combination thereof. The processor can be a Central Processing Unit (CPU), or other general-purpose processors, digital signal processors (DSP), application-specific integrated circuits (ASIC), field-programmable gate arrays (FPGA), or other programmable logic devices, discrete gates, or transistor logic devices, discrete hardware components, etc., which will not be limited in the disclosure and can be determined based on specific circumstances.

It should be noted that this specification provides method operation steps as described in the embodiments or diagrams, but based on routine or non-creative work, there the method can include more or fewer operation steps. The order of steps listed in the embodiments is just one way of executing the numerous steps, which does not represent the only execution sequence. In actual implementation of systems or device products, the methods shown in the embodiments or the flowcharts can be executed sequentially or in parallel.

Finally, it should be noted that the above description is only about preferred embodiments of this disclosure, which is not intended to limit this disclosure. Although detailed descriptions have been provided for the aforementioned embodiments, those skilled in the art can still modify the technical solutions described in the aforementioned embodiments or equivalently alternations can be made to some of the technical features. Any modifications, equivalent alternations, improvements, etc. made within the spirit and principle of this disclosure should be included within the protection scope of this disclosure.

1. A LIDAR, comprising:
a transmitter device configured to transmit a detection light beam for detecting an object,
a detector device comprising a plurality of detector units, a first detector unit of the plurality of the detector units comprising a first pixel array, the first pixel array comprising a first pixel and a second pixel adjacent to the first pixel, wherein the first pixel is configured to respond to an echo of the detection light beam reflected from the object and convert the echo into a first electrical signal, and the second pixel is configured to respond to the echo of the detection light beam reflected from the object and convert the echo into a second electrical signal,
a data processor device coupled with the detector device and configured to:
reconstruct the first electrical signal and the second electrical signal to obtain a first reconstructed signal array comprising a first reconstructed electrical signal, and
determine a point cloud based on the first reconstructed signal array,
wherein the first reconstructed electrical signal is obtained based on the first electrical signal and the second electrical signal.

2. The LiDAR of claim 1, wherein the first pixel comprises a plurality of single photon avalanche diodes, a single photon avalanche diode of the plurality of the single photon avalanche diodes being addressable, and wherein the data processor device is configured to traverse and reconstruct the first electrical signal and the second electrical signal to obtain the first reconstructed signal array.

3. The LiDAR of claim 1, wherein the first detector unit corresponds to a first field of view of the LiDAR, and wherein the plurality of detector units comprises a second detector unit comprising a second pixel array, the second detector unit corresponds to a second field of view of the LiDAR.

4. The LiDAR of claim 3, wherein the first detector unit and the second detector unit are two detector units of a same configuration, and wherein the data processor device is further configured to reconstruct a plurality of third electrical signals output by the second pixel array of the second detector unit to obtain a second reconstructed signal array.

5. The LiDAR of claim 4, wherein the data processor device is further configured to generate m points in the point cloud based on the first reconstructed signal array, and generate n points in the point cloud based on the second reconstructed signal array, wherein m is greater than n.

6. The LiDAR of claim 1, wherein the data processor device is further configured to:
obtain a ROI around the LiDAR, and
set a detector unit corresponding to the ROI as the first detector unit.

7. The LiDAR of claim 1, wherein the data processor device is further configured to perform convolution on the first electrical signal and the second electrical signal using a convolution kernel and a convolution stride, to obtain the first reconstructed signal array.

8. The LiDAR of claim 7, wherein the convolution stride is configured to be adjustable based on a field of view corresponding to the first detector unit.

9. The LiDAR of claim 8, wherein a convolution stride of a central area of the field of view of the LiDAR is smaller than a convolution stride of a marginal area of the field of view.

10. The LiDAR of claim 1, wherein the transmitter device comprises a plurality of transmitter units, and a number of rows of the first reconstructed signal array is greater than a number of the plurality of transmitter units.

11. The LiDAR of claim 1, wherein a dimension of the first reconstructed signal array is less than a dimension of the first pixel array.

12. A data processing method for a LiDAR comprising a detector device, wherein the detector device comprises a plurality of detector units, a first detector unit of the plurality of detector units comprising a first pixel array, the first pixel array comprising a first pixel and a second pixel adjacent to the first pixel, wherein the first pixel is configured to respond to an echo of a detection light beam reflected from an object and convert the echo into a first electrical signal, and the second pixel is configured to respond to the echo of the detection light beam reflected from the object and convert the echo into a second electrical signal, the data processing method comprising:
reconstructing the first electrical signal and the second electrical signal to obtain a first reconstructed signal array comprising a first reconstructed electrical signal, and
determining a point cloud based on the first reconstructed signal array,
wherein the first reconstructed electrical signal is obtained based on the first electrical signal and the second electrical signal.

13. An integrated light detection and data acquisition and processing device comprising:
a plurality of detector units, a first detector unit of the plurality of the detector units comprising a first pixel array, the first pixel array comprising a first pixel and a second pixel adjacent to the first pixel, wherein the first pixel is configured to respond to an echo of the detection light beam reflected from the object and convert the echo into a first electrical signal, and the second pixel is configured to respond to the echo of the detection light beam reflected from the object and convert the echo into a second electrical signal, and
a data acquisition and processing device coupled with the plurality of the detector units and configured to:
reconstruct the first electrical signal and the second electrical signal to obtain a first reconstructed signal array comprising a first reconstructed electrical signal, and
determine a point cloud based on the first reconstructed signal array,
wherein the first reconstructed electrical signal is obtained based on the first electrical signal and the second electrical signal.
